(19) United States
(12) Patent Application Publication
(10) Pub. No.: US 2008/0148569 A1
(43) Pub. Date: Jun. 26, 2008

(54) RECEIVER TANK FOR A CONDENSOR AND METHOD OF MANUFACTURING THE SAME

(75) Inventors: Ramesh K. Shah, New Delhi (IN); A. S. Ravi Kumar, New Delhi (IN); Nikhil Karwall, New Delhi (IN)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: SUBROS LIMITED, New Delhi (IN)

(21) Appl. No.: 12/043,626

(22) Filed: Mar. 6, 2008

Related U.S. Application Data
(62) Division of application No. 11/100,241, filed on Apr. 6, 2005.

(30) Foreign Application Priority Data
Dec. 10, 2004 (IN) 2463/DEL/2004

(51) Int. Cl. B23P 17/00

(52) U.S. Cl. 29/890.07

(57) ABSTRACT

The invention provides for a receiver tank for an automobile air conditioner condenser comprising: a first half having two openings for refrigerant inlet and outlet, a second half to be joined with the first half to form the receiver, at least one of the first or second half having means to join with the other half.

### FIELD OF INVENTION

The invention relates to condensers in an air-conditioning system and more particularly condensers for automobile air-conditioners.

At the outset, caulking as a process with reference to this invention refers to a joining process wherein two components are crimped, bent, or deformed at the joining juncture, without the use of any external filler material. Caulking is usually carried out prior to brazing in the brazing furnace to ensure that the components to be brazed are retained against each other.

### BACKGROUND OF THE INVENTION

An air-conditioning system typically consists of the following components: a compressor, condenser, expansion valve and evaporator. The condenser receives high pressure, high temperature gaseous refrigerant from the compressor. The condenser is functional in condensing the refrigerant vapors to the liquid phase. The high-pressure condensed liquid refrigerant is converted to low-pressure liquid/vapor refrigerant in the expansion device and is finally sent to the evaporator where the refrigerant evaporates. The vaporized refrigerant is then sent to the compressor to be recycled through the system.

However, a common drawback with the typical air-conditioning system is that the refrigerant leaving the condenser is not always in the completely liquid phase. To remedy this situation, the air-conditioning system is provided with a receiver-tank that receives the refrigerant from the condenser before passing it to the expansion device. The primary purpose of the receiver-tank is to ensure that all refrigerant passed to the expansion device is in the liquid phase. This in turn ensures that the refrigerant entering the evaporator is of low quality and low enthalpy, so as to increase the evaporator's ability to absorb heat from the ambient surroundings. The receiver tank acts as a reservoir for excess liquid refrigerant to assure that only liquid is fed to the expansion device in spite of system changes typically caused by the operation of the compressor. For example, in an automotive air-conditioning system, the compressor is frequently stopped and started.

Additionally, the receiver-tank is also provided with means for removing moisture from the refrigerant to assure its purity and possible internal corrosion of the evaporator.

Initially, the receiver-tank was formed as a unit separate from the condenser, placed downstream of the condenser and upstream of the expansion device and connected to these devices by appropriate piping. In such a situation, the packaging space is increased by an amount at least that of the receiver-tank. It is also necessary to secure the receiver-tank to the vehicle body in such a manner that it is sufficiently durable against vibration independent of the condenser. Furthermore, the manufacture, part control, and assembly work of the connecting means between the condenser and the receiver-tank is required, which eventually increases the cost of the vehicle air-conditioner.

Japanese patents 3-87572, 4-103973 and 4-131667 have attempted to remedy this situation by providing solutions such as directly brazing together of components. However, the solutions offered by these patents also have limitations. For example: In Japanese patent 4-103973 in assembling the receiver tank and the condenser, the first header pipe of the condenser is connected to the receiver tank by brazing. However, the brazing of those members, especially the receiver tank is difficult, because they are each in the form of a cylinder that is large in thermal capacity. That is, the header and the receiver tank are combined with other members forming the condenser and fixed with a jig and then the resultant assembly is set in a heating furnace. In the heating furnace, the assembly is heated at a temperature which is higher than the melting point of the brazing material applied to at least one of the two members (which are to be connected to each other) and is lower than the melting point of the base material. In those members, the brazing material on each member is melted so as to be connected to the mating member. In the above-described members the first header pipe and receiver tank are both large in thermal capacity, and therefore the brazing of those members is rather difficult. That is, the members are increased in temperature slowly when compared with the other members; i.e. the melting of the brazing material on at least one of the two members takes time so that the resultant brazing of the two members is liable to be unsatisfactory. In addition, the time required for those members to be connected to each other by brazing is unavoidably long; i.e. the assembling work of the receiver tank and the condenser is low in work efficiency. Since the header and the receiver tank are cylindrical, the contact surface of them is linear, so that the brazing area is small, and the coupling force is not great enough.

Japanese Patent Application No. 4-320771 discloses a technique of forming a flat portion on a side surface of the header of the condenser together with forming a flat portion also on the receiver tank and performing integral brazing with the two flat portions in an aligned state. The method allows for an increase in area of contact and therefore provides for a stronger braze. However, during brazing the header and the receiver tank are retained byjigs of wire, and the provisional retaining force declines in the furnace due to change in thickness of respective members due to melting of brazing material, change in hardness of respective members etc. Further, the joining surfaces of the header and receiver tank are susceptible to slippage and rate of joining defects due to slippage is high.

U.S. Pat. No. 6,052,899 overcomes some of the aforementioned difficulties by providing a coupling bracket or connector that is smaller in thermal capacity than the header of the condenser and the receiver tank. One end of the coupling bracket is secured to the outer cylindrical surface of the header and the other end is secured to the outer surface of the receiver tank by brazing. The provision of coupling brackets or connectors to join the header and the receiver tank allows for better brazing characteristics. Also as the area of the junction of the coupling bracket and the receiver tank and the header are large enough the coupling force of the two members is high.

Typically two connectors are used between the header and the receiver tank. The connectors are hollow in that they have a path for the refrigerant to flow through them. Two holes, one inlet and one outlet are made on corresponding locations of the header and the receiver tank. Refrigerant on passing through the condenser core is outlet to the receiver tank where liquid refrigerant only is outlet to the sub cooling stage of the condenser.

However, the use of connectors or coupling brackets suffers from manufacturing drawbacks specifically in the joining of the connector to the header and the receiver tank. The connecting members are first caulked and then brazed to both the header and the receiver tank. One end of the connector is inserted into a hole in the condenser header and the other end of the connector is inserted into a corresponding hole of the receiver tank. The ends that are inserted into the header and receiver tank respectively are then caulked with the help of special and expensive tooling. (figure here showing header and receiver in dotted lines, connector ends before and after caulking). However, as the receiver tank is an extruded component and has a closed body, the caulking of the connectors with the receiver is a difficult and complicated process. Long tools are inserted into the receiver body to flare the connector end. This process sometimes also results in the tool damaging the threaded portion of the receiver that receives the cap filter sub-assembly. This results in the entire receiver tank being rejected. Poor caulking can lead to degraded brazing performance at the joining surfaces that in turn may result in refrigerant leakage. The complicated caulking process also requires expensive tooling and often results in higher rejections. Furthermore, the internal threads also tend to get damaged as some filler material of the brazing operation may flow into the threads and render them ineffective. In this case, the entire condenser along with the receiver tank has to be rejected as scrap as they have been brazed. This proves to be a strong economic deterrent of the existing receiver tanks.

### BRIEF SUMMARY OF THE INVENTION

The invention provides for an improved receiver tank for a condenser that allows for ease in manufacturing.

The invention provides for an improved receiver tank for a condenser that does not require expensive and complicated tooling.

The invention provides for an improved receiver tank for a condenser that provides for savings in cost and reduction in manufacturing waste.

The invention provides for an improved method of manufacturing a receiver tank for a condenser that does not require expensive and complicated tooling.

The invention provides for an improved method of manufacturing a receiver tank for a condenser that provides for savings in cost and reduction in manufacturing waste.

To meet the aforementioned objectives the invention provides for a receiver tank for an automobile air conditioner condenser comprising:
a first half having two openings for refrigerant inlet and outlet,
a second half to be joined with the first half to form the receiver,
at least one of the first or second half having means to join with the other half.

The invention also provides for a method of manufacturing an integrated receiver condenser wherein a first half and a second half of a receiver are joined together to form the receiver.

### BRIEF DESCRIPTION OF SEVERAL VIEWS OF THE DRAWINGS

The accompanying drawings illustrate the preferred embodiments of the invention and together with the following detailed description serve to explain the principles of the invention.

FIG. 1 illustrates an integrated condenser with the receiver tank in accordance with the invention.

FIG. 2 illustrates the receiver tank in a disassembled state in accordance with the invention.

FIG. 3 illustrates the first step in the method of manufacturing the integrated condenser with the receiver tank in accordance with the invention.

FIG. 4 illustrates a rear and perspective view of the left half of the receiver tank with connectors.

FIG. 5 illustrates the second step in the method of manufacturing the integrated condenser with the receiver tank in accordance with the invention.

FIG. 6 illustrates the left half of the receiver tank with a cap support.

FIG. 7 illustrates the third step in the method of manufacturing the integrated condenser with receiver tank in accordance with the invention.

FIG. 8 illustrates a rear view of the left half of the receiver tank connected to the header of the condenser.

FIG. 9 illustrates a perspective view of FIG. 8.

FIG. 10 illustrates the fourth step in the method of manufacturing the integrated condenser with receiver tank in accordance with the invention.

FIG. 11 illustrates the tank header connected to the condenser in accordance with the invention.

FIG. 12 illustrates the fifth step in the method of manufacturing the integrated condenser with receiver tank in accordance with the invention.

FIG. 13 illustrates the front view of the separator of the receiver tank connected to the right half of the receiver tank.

FIG. 14 illustrates the rear view of the separator of the receiver tank connected to the right half of the receiver tank.

FIG. 15 illustrates the sixth step in the method of manufacturing the integrated condenser with receiver tank in accordance with the invention.

FIG. 16 illustrates the receiver tank connected to the condenser in accordance with the invention.

FIG. 17 illustrates the cap receiver of the receiver tank.

FIG. 18 illustrates the assembled state of the receiver tank with cap receiver.

FIG. 19 illustrates the cap filter sub-assembly of the receiver tank.

FIG. 20 illustrates the assembled state of the cap filter sub-assembly and the receiver tank.

FIG. 21 illustrates the connectors that are used to connect the receiver tank with the condenser.

FIG. 22 illustrates the caulking process of the connectors with the header and the receiver.

FIG. 23 illustrates the receiver tank in accordance with this invention with the connectors before caulking.

FIG. 24 illustrates the receiver tank in accordance with this invention with the connectors after caulking.

FIG. 25 illustrates the final receiver tank connected to the tank header in accordance with this invention.

FIG. 26 illustrates an embodiment of the invention with receiver support.

FIG. 27 illustrates an embodiment of the invention.

FIG. 28 illustrates the method of the embodiment as shown in FIG. 27.

FIG. 29 illustrates an embodiment of the invention.

FIG. 30 illustrates the method of the embodiment as shown in FIG. 29.

FIG. 31 illustrates an embodiment of the invention.

FIG. 32 illustrates an embodiment of the invention.

FIG. 33 illustrates the gap between the receiver and the condenser.

FIG. 34 illustrates the receiver in accordance with an embodiment of the invention.

FIG. 35 illustrates the receiver in accordance with an embodiment of the invention.

### DETAILED DESCRIPTION OF PREFERRED EMBODIMENTS OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

Through out the patent specification, a convention employed is that in the appended drawings, like numerals denote like components.

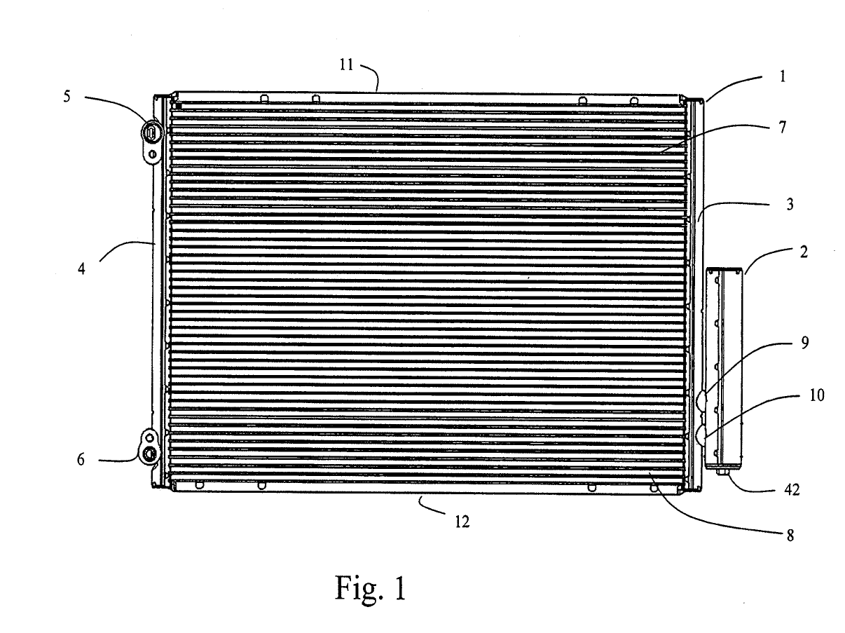

With reference now to FIG. 1, an integrated condenser (1) with the receiver tank (2) in accordance with the first embodiment of the invention is shown. The condenser has a pair of vertically oriented headers (3,4) horizontally spaced apart from each other. Each header, on the side facing the other, has a plurality of tube slots that are aligned with the tube slots of the opposite header. A plurality of tubes (7, 8) extends between these slots and have their ends received in sealed relation in the slots. The condenser is also provided with fins (not shown) between the tubes to aid in dissipating heat. The tubes (7) form the condensing portion. The tubes (8) are the tubes of the sub-cooling section. The refrigerant from the condenser enters the receiver tank (2) through receiver inlet (9) and the refrigerant leaving the receiver tank through the receiver outlet (10) passes through these tubes, thereby being sub-cooled, before leaving the sub-cooler at outlet (6).

Side plates (11,12) are joined to the first and second header (3,4) at both ends maintaining the strength of the refrigerant condenser (1).

High pressure, high temperature gaseous refrigerant from the compressor enters the condenser through inlet (5) in the second header (4). The refrigerant then flows though a series of passes between the first header (3) and second header (4), before finally exiting the condenser tubes (7) at receiver inlet (9).

The receiver has a vapor-liquid separation chamber for separating vapor-liquid of refrigerant. The receiver may be provided with means for filtering the refrigerant as well as for removing moisture from the refrigerant to assure its purity, thereby avoiding inefficient operation. Liquid refrigerant from the receiver tank leaves the receiver tank from the receiver outlet (10). This liquid refrigerant is then sub-cooled in the sub-cooler (8) and finally leaves the sub-cooler at outlet (6).

As can be seen from the figure, the receiver tank (2) and the first header (3) are cylindrical with connectors between them. Optionally, the receiver tank and the header may be of an elliptical, rectangular or other geometrical profile. The first header (3) consists of two halves, a plate header (31) and a tank header (27) as shown in Figure (10). It is the tank header to which the receiver is connected. Caulking a connector to the tank header (27) is not difficult as the tank header has an open profile. However, caulking the connector to the receiver tank (2) requires inserting the connector into the hole made in the cylindrical receiver and caulking it at its inside edge, which is a complicated task.

The invention therefore resides in splitting the receiver tank in two halves and a method of manufacturing an integrated condenser receiver using the split receiver tank. At least one of the two halves are provided with means to join with the other half. These means may be ribs for caulking or slots for a sliding connection.

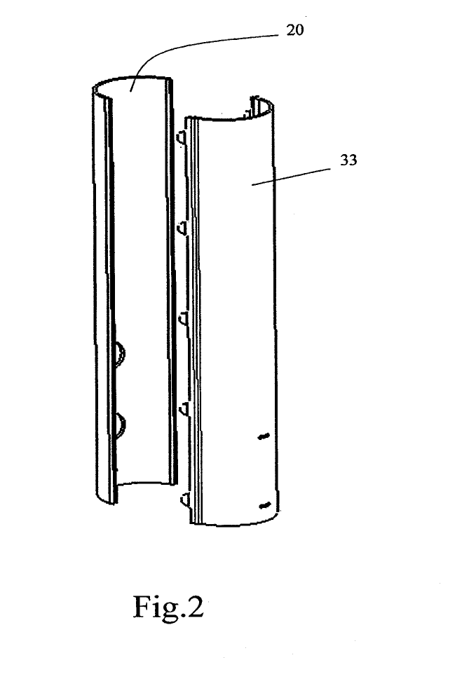

The novel receiver tank in accordance with the invention may be better visualized with reference to FIG. 2, wherein the receiver tank has been split into two halves (20, 33).

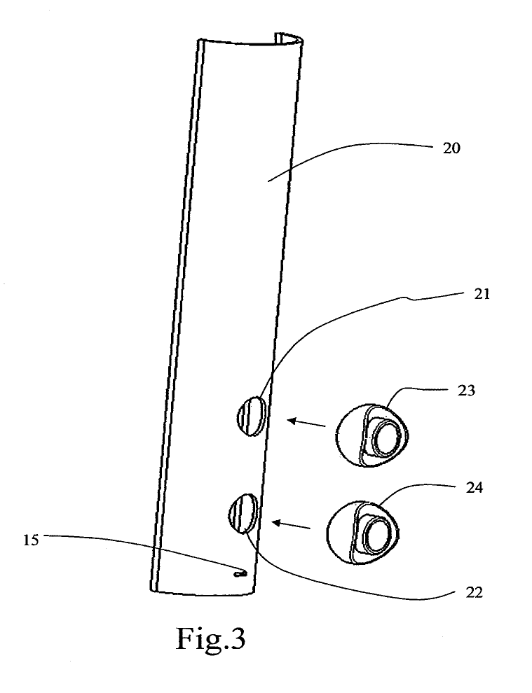

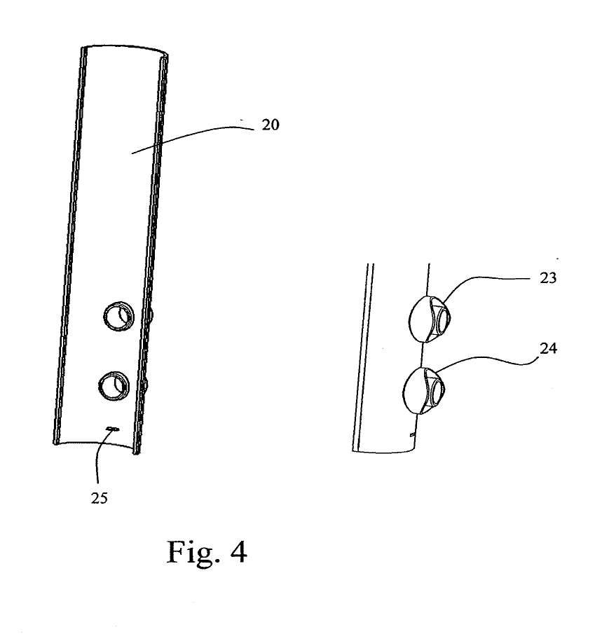

With reference now to FIG. 3, the first or left half (20) of the receiver tank (2) is shown. The left half has two holes namely receiver inlet (21) and receiver outlet (22). One end of the connectors (23, 24) is inserted into these holes respectively, as a first step in the manufacturing process. The connectors are caulked to the left half of the receiver using conventional caulking tools. With the rear side of the left half being open the caulking process is substantially simplified since ample space is available for the tool to directly apply force on the connectors. The left half (20) is also provided with a slot (25) into which a corresponding rib of a cap support is caulked, at a later stage. The left half (20) as caulked to the connectors is shown in FIG. 4.

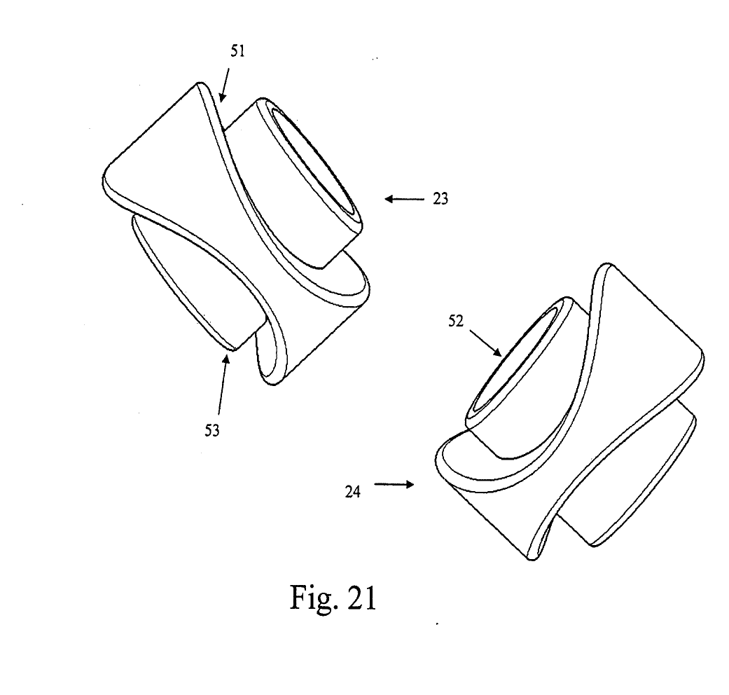

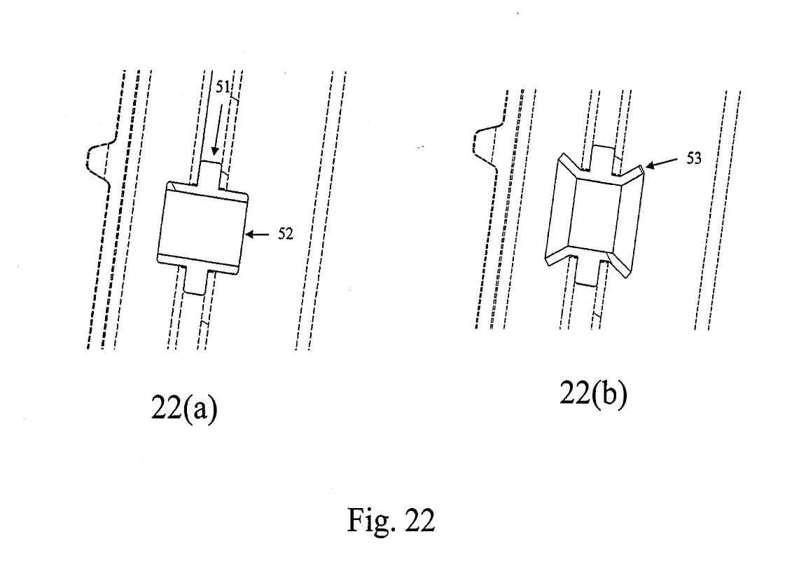

The connectors in accordance with an embodiment of the invention may be better understood with reference to FIG. 21. The figure shows the two connectors 23 and 24 having a central hollow cylindrical portion (52) that allows for the refrigerant passage between the header of the condenser and the receiver. This cylindrical portion (52) enters the tank header at one end and the receiver tank at the other end. The ends (53) of the connectors are then caulked to provide a secure fit between the connector, the header and the receiver. The connectors also have a profile (51) that exactly matches that of the component to which they are being connected. Thus the profile (51) matches with the outer surface of the header at one end and the receiver tank at the other end. This in turn provides for a secure and snug fit and does not allow any play between the components being joined. The caulking process has been illustrated in FIG. 22, wherein FIG. 22 (a) shows the hollow cylindrical portion (52) of the connector inserted into the header and the receiver. FIG. 22 (b) depicts the ends (53) of the connectors flared by caulking.

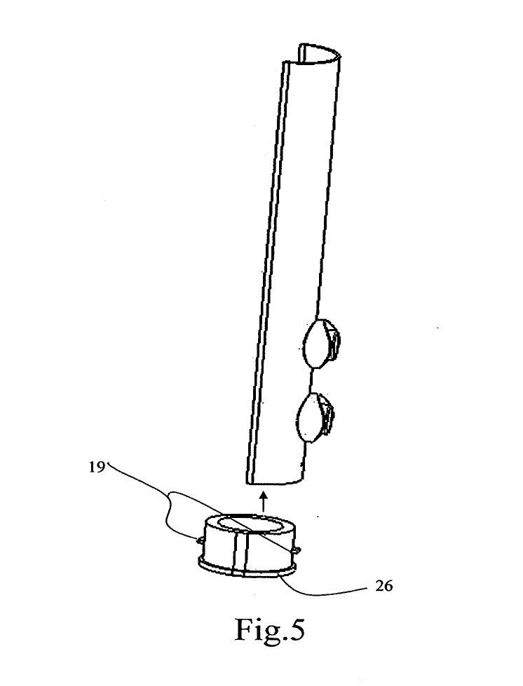

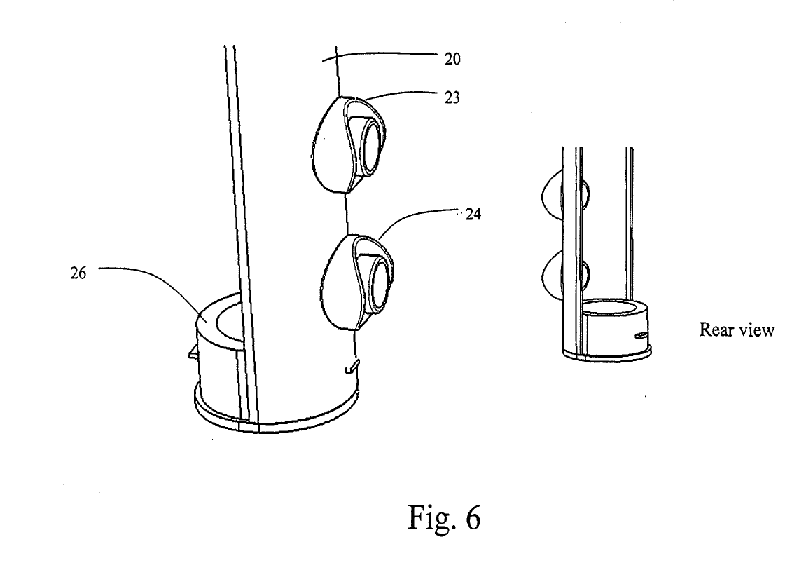

A cap support (26) in accordance with this embodiment of the invention is then attached to the lower end of the left half as shown in FIG. 5. The cap support (26) has two ribs (19) on its outer periphery one of which mates with corresponding slot (25) in the left half (20), and is caulked thereof. The caulking is performed in a way to cause the flaring of the rib at its respective position, thereby causing the cap support to be rigidly joined to the left half of the receiver (20). The cap support is an internally threaded component provided for the provision of a service cap called the cap filter sub-assembly (42). The left half of the receiver tank (20) with the connectors and the cap support is shown in FIG. 6.

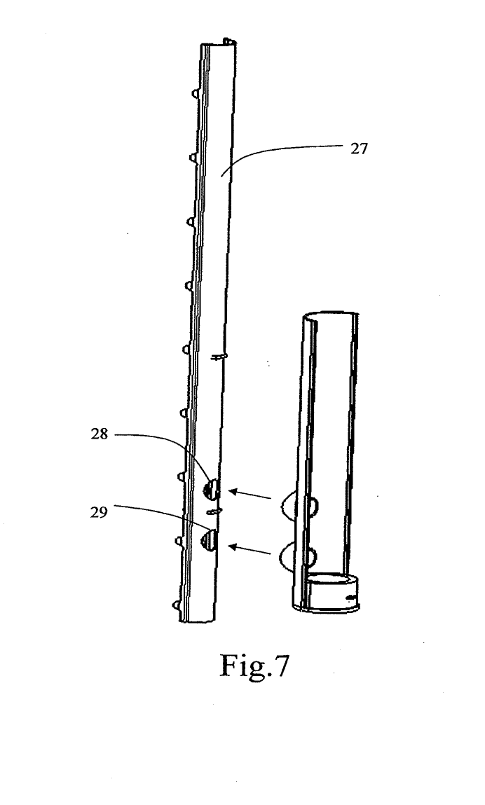

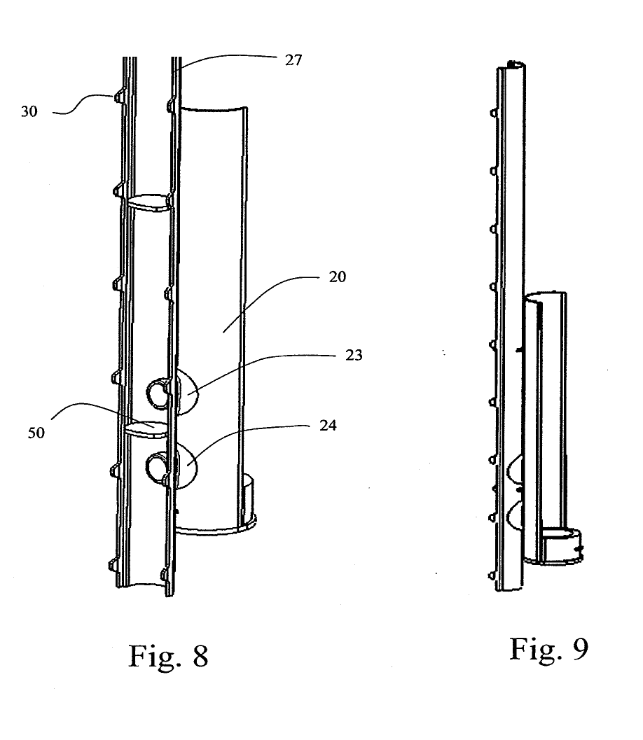

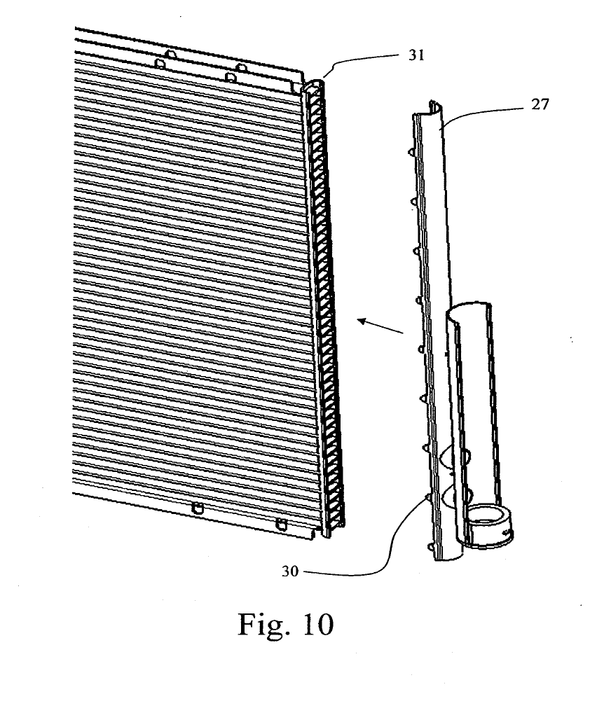

With reference now to FIG. 7, the left half of the receiver tank (20) as shown in FIG. 6 is now connected to the tank header (27) of the first header (3). The tank header consists of a condenser outlet (28) and a sub-cooler inlet (29). The other ends of the two connectors are now inserted into corresponding holes (28, 29) of the tank header. The connectors are caulked to the tank header in the same manner, as they were to the left half of the receiver tank. Again, the rear half of the tank header being open the caulking process is not complicated. FIGS. 8 and 9 illustrate a rear and perspective view of the tank header connected to the left half of the receiver tank by connectors. As can also be seen from FIG. 8, the headers are provided with separators (50) that form passes for the refrigerant to flow between the two headers.

The tank header also has ribs (30) on its edges that are used to caulk the tank header to the plate header.

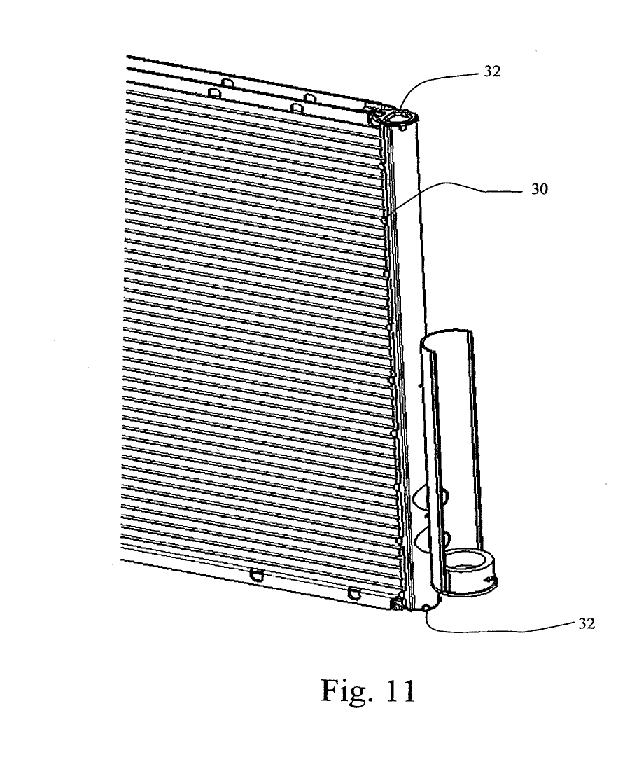

The tank header (27) is now connected to the plate header (31) of the first header (3) to complete the condenser assembly, as shown in figure (10). The tank header is caulked to the plate header by the tank header ribs (30), as may be seen in FIG. 11. The ribs (30) of the tank header are bent so as come in contact with the outer surface of the plate header. The top and bottom surfaces of the first header (3) are closed by means of header caps (32).

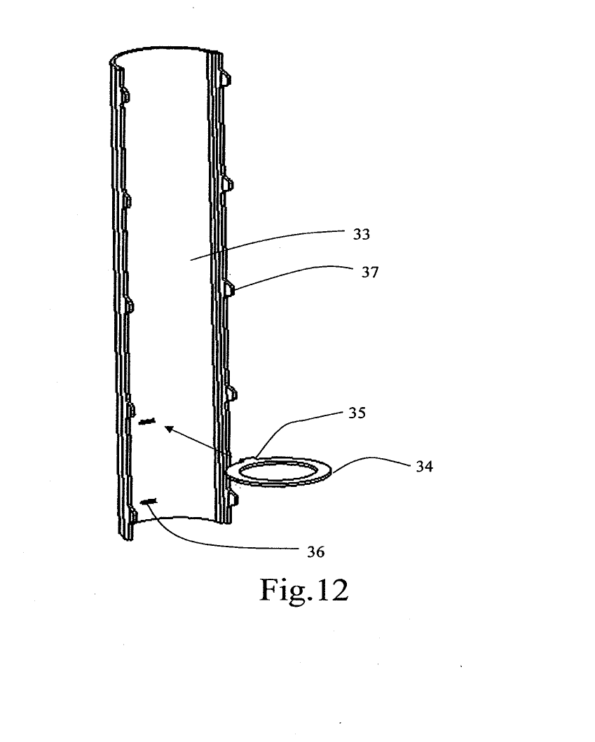

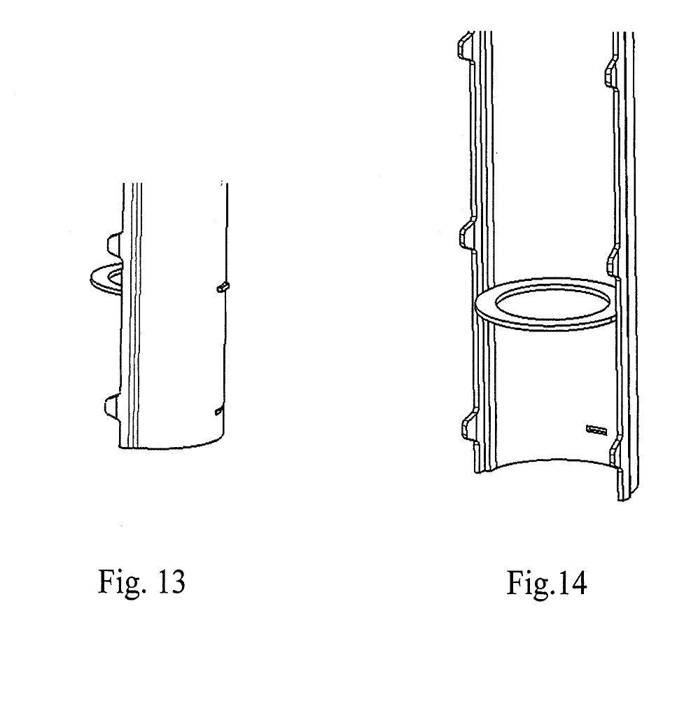

The other or right half (33) of the receiver tank (2) is attached to a separator (34) that has rib (35), as shown in FIG. 12. The right half (33) of the receiver tank has slots (36) one of which receives the rib (35). The separator is caulked to the right half (33) of the receiver tank in a manner similar to the caulking of the cap support, as illustrated by the front and rear views of FIGS. 13 and 14. The separator is required inside the receiver tank for supporting the desiccant bag and has a through hole for allowing refrigerant passage.

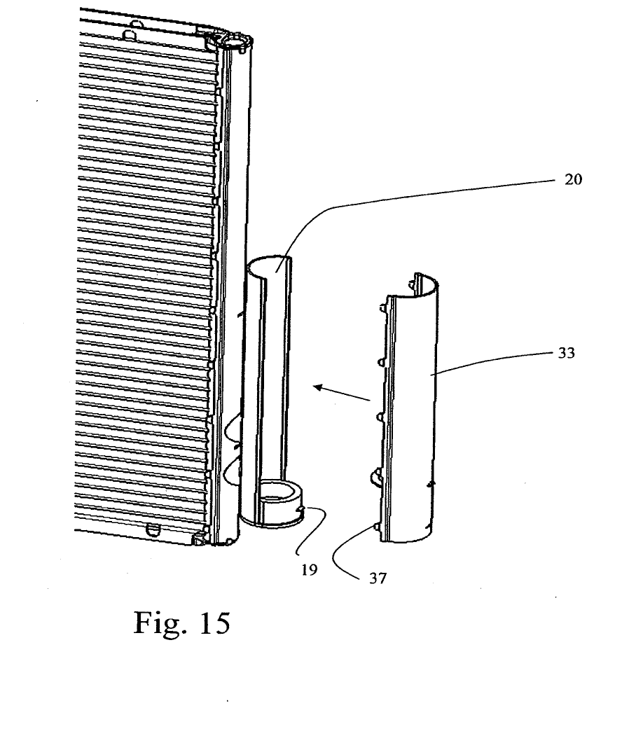

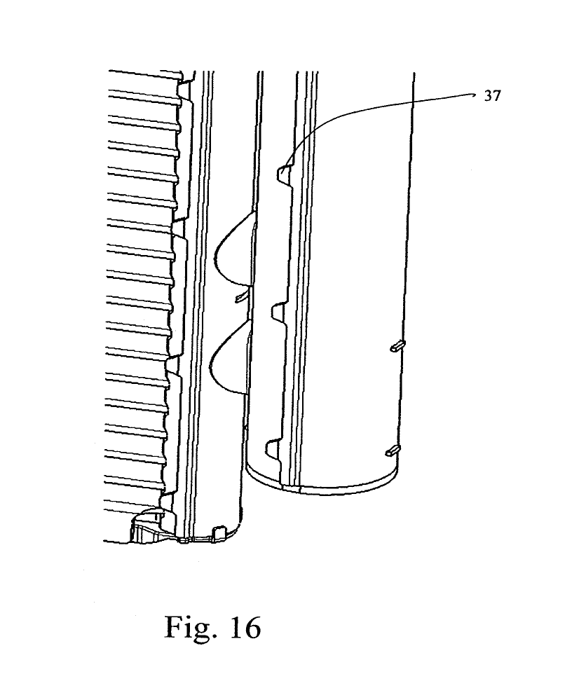

The right half (33) of the receiver tank has ribs (37) at its edges. Referring now to FIG. 15 when the two halves of the receiver tank are joined the separator (34) fits perfectly with the inner profile of the left half of the receiver tank (20). The free rib (19) of the cap support (26) is inserted into the lower slot of the right half (33) of the receiver tank and is caulked into position. The ribs (37) are caulked to the left half of the receiver tank in a manner similar to the caulking of the tank header to the plate header. This results in a whole receiver tank (2) as shown in FIG. 16.

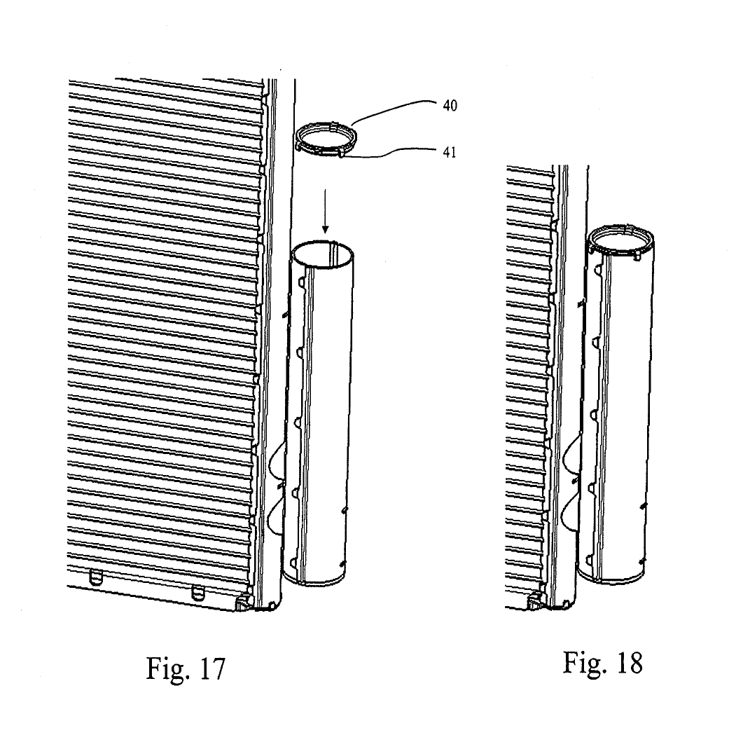

To complete the receiver tank, a receiver cap (40) with ribs (41) is caulked to the upper end of the receiver tank, and is depicted by FIG. 17. The caulking is performed using the claw like ribs of the receiver cap. This further strengthens the attachment between the two halves of the receiver tank. The receiver tank with the receiver cap fitted is shown in FIG. 18.

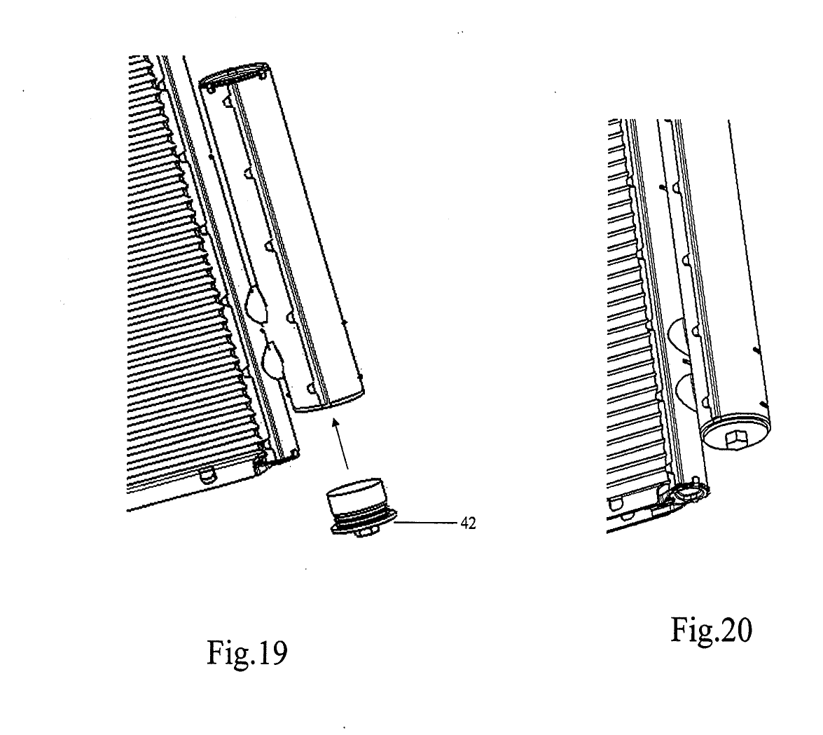

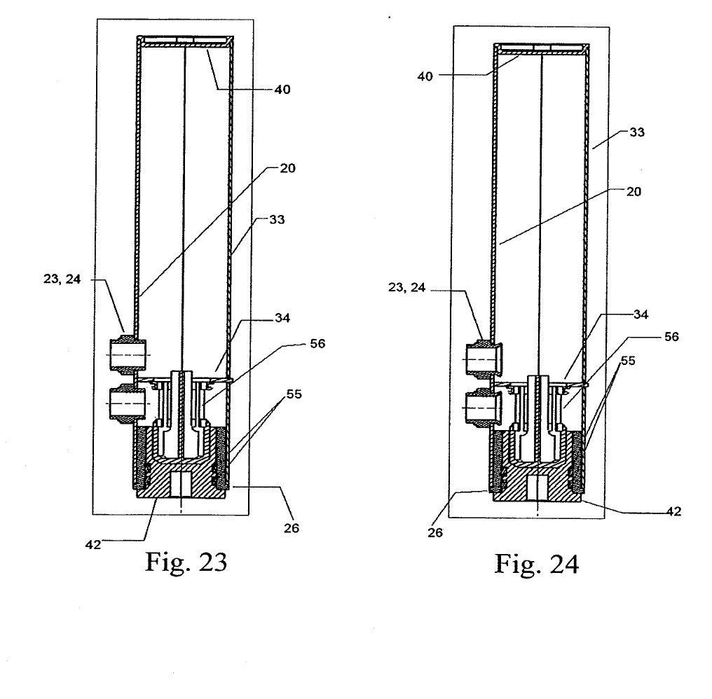

As mentioned earlier and as illustrated by FIGS. 19 and 20, a cap filter sub-assembly (42) with external threads is fitted onto the support cap, by means of a threaded joint. With reference now to FIG. 23, the cap filter sub-assembly is an externally threaded component provided with a filter mesh (56) for the purpose of filtering the refrigerant. The refrigerant leaving the receiver has to pass through the filter (56) before leaving by receiver outlet. O-rings are provided between the cap support and the cap filter sub assembly to maintain the leak proof joint. The threaded cap filter sub assembly allows the filter to be removed for cleaning of the filter (55). The cap filter sub assembly is fitted in a manner such that the top edge abuts the separator. This arrangement ensures no refrigerant by passes the filter. FIG. 24 illustrates receiver tank of FIG. 23 after the connectors have been caulked.

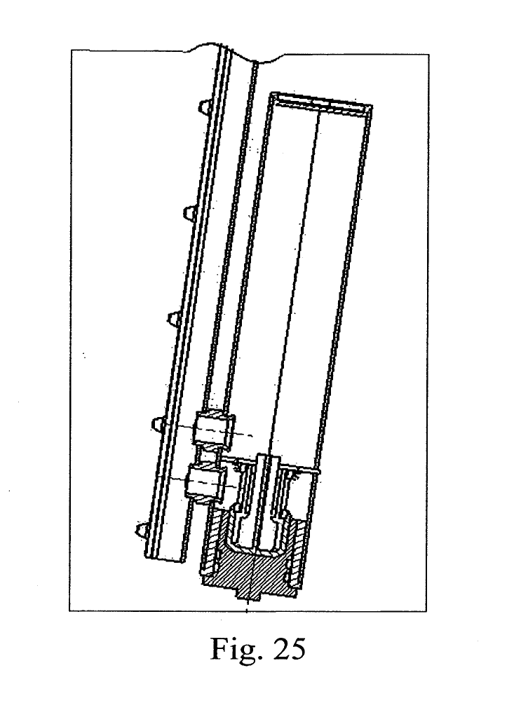

FIG. 25 illustrates the final receiver tank connected to the tank header in accordance with this invention. The tank header is then connected to the plate header and the entire assembly is brazed at one time.

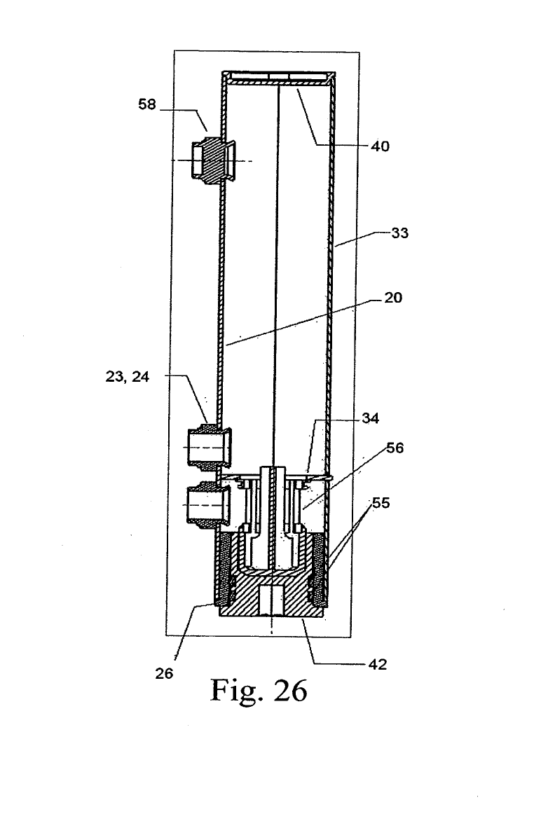

FIG. 26 illustrates an embodiment of the invention wherein a receiver support (58) is provided to the receiver tank. The receiver support (58) is essentially a connector with its cylindrical portion not being hollow. Thus no refrigerant can flow through this connector. The support (58) is provided for a stronger joint between the header and the receiver.

The invention thus also simplifies the manufacturing process by eliminating the internally threaded receiver tank with a cap support that has internal threads. Thus damage to the threads during the process of caulking is also avoided since cap support is added to the assembly after the caulking process.

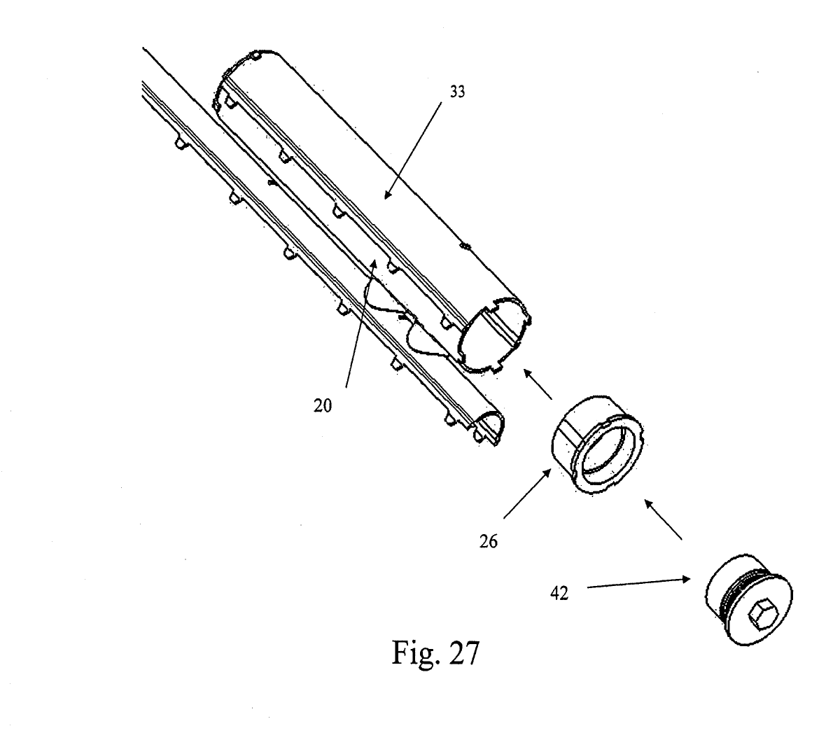

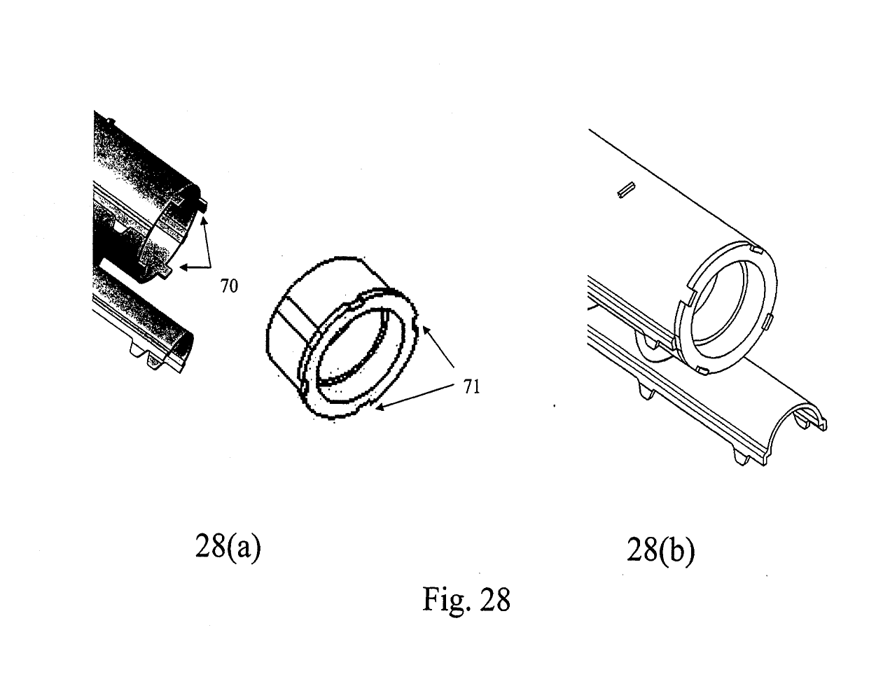

In an alternate embodiment, another method of assembling the cap support to the two halves of the receiver is described. With reference now to FIG. 27 the receiver tank two halves (20, 33) are provided with ribs (70) that fit into corresponding slots (71) on the cap support (26). The ribs are then caulked to the cap to strengthen the attachment. The process of caulking the ribs (70) into the slots (71) is shown in FIGS. 28(a) and 28(b).

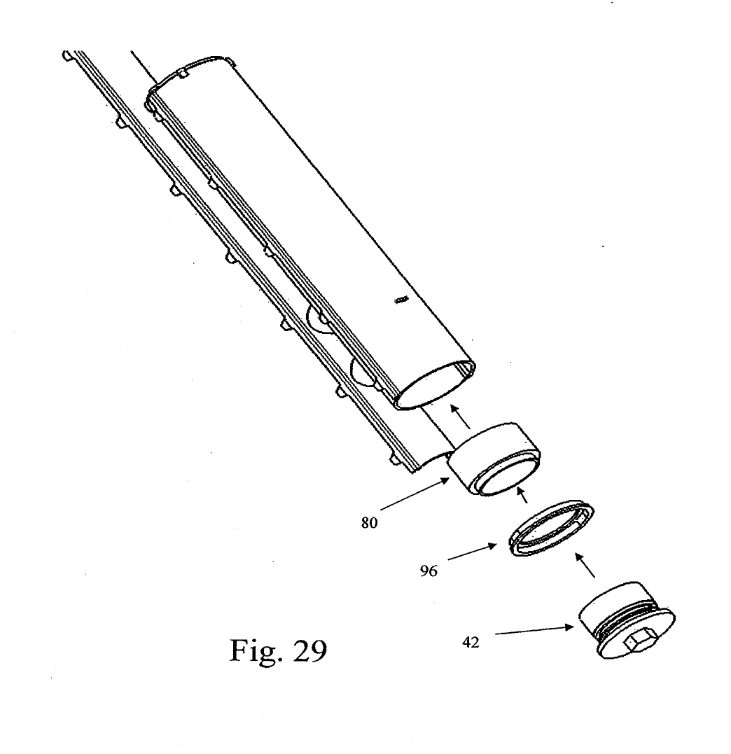

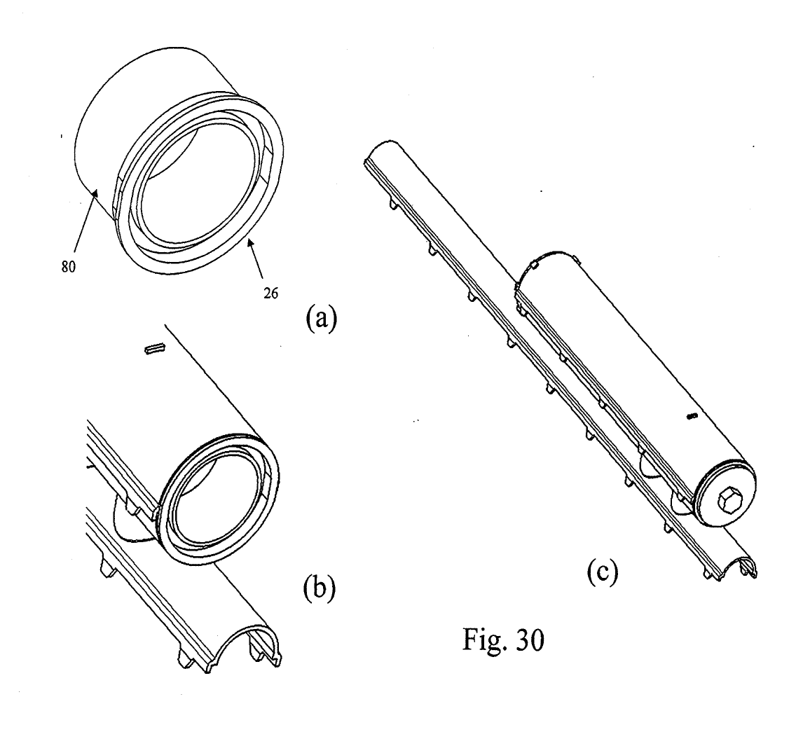

FIG. 29 illustrates another embodiment of the invention wherein an internally threaded member (80) is provided in addition to the support cap (96) and the cap filter sub-assembly (42). Essentially the cap support (26) in accordance with this embodiment has been split into the threaded component (80) and the support cap (96). The threaded member is caulked to the support cap. The support cap is in turn caulked to the receiver body. The cap filter sub assembly is screwed in to the threaded member (80). The support cap (96) has ribs to caulk it to the receiver. The edge of the threaded member is flared once fitted in to the support cap (96). The process of forming the final receiver in accordance with this embodiment of the invention is shown in FIG. 30 (a to c).

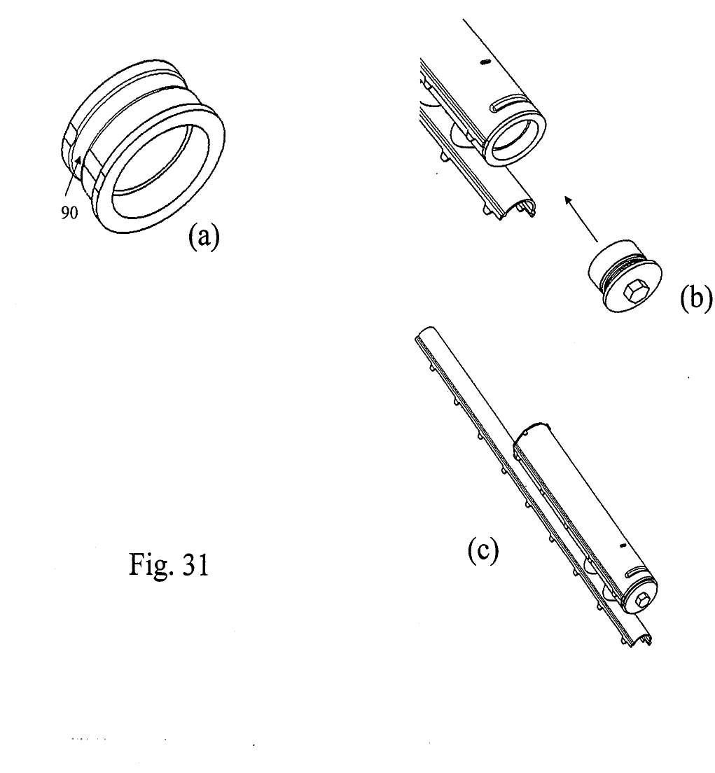

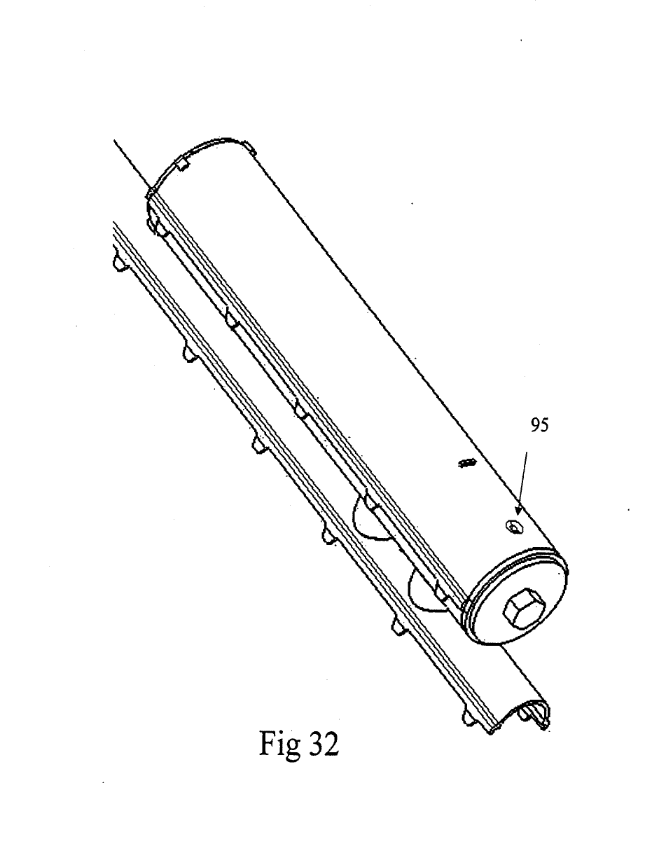

FIG. 31 (a, b, c) illustrates another embodiment of the invention wherein the cap support (26) is provided with a groove (90) at the periphery. The cap support has internal threads. The cap support is inserted into the receiver and both the halves of the receiver are pressed in to these grooves to strengthen the attachment. The cap filter sub-assembly is threaded in to the cap support. Alternatively, as shown in FIG. 32, both halves of the receiver may be punched at a spot (95) so as to fit into the groove of the support cap. Again, in a further embodiment, the receiver halves may be provided with depressions before the cap support is fitted.

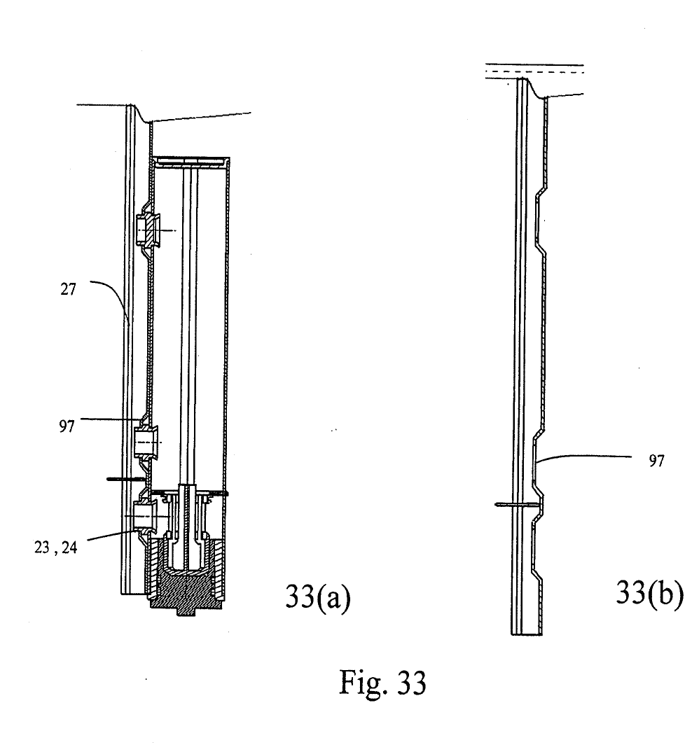

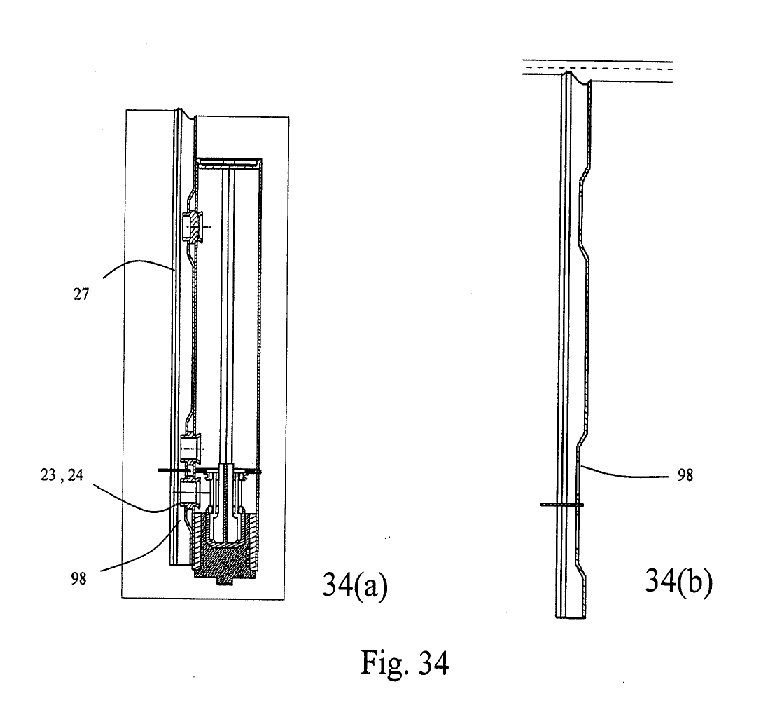

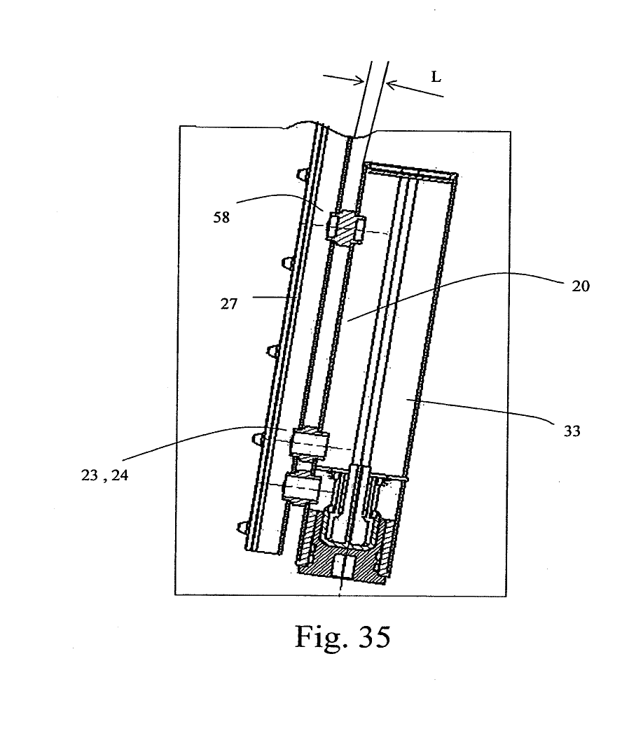

With reference now to FIG. 33, ‘L’ denotes the gap between the receiver and the condenser. This gap though small, results in an increase in space requirements. Also during the opening or closing of the cap filter sub assembly a torque acts on the receiver, and this torque may result in the weakening of the joint between the connectors and the receiver and the condenser. One way of reducing the torque is to move the receiver drier closer to the condenser tank header. In accordance with this proposition, in this embodiment, the connectors have been moved a little inwards into the tank headers. This reduces the torque acting on the receiver while the opening and closing of the cap filter sub assembly by a considerable amount and minimizes the chances of rupture. As shown in FIGS. 34 and 35, the tank header has a region that is indented to accommodate the connectors.

Another advantage provided by this particular embodiment is that the entire assembly takes up lesser space in the engine cabin area since the receiver is moved closer to the condenser.

It will readily be appreciated by those skilled in the art that the present invention is not limited to the specific embodiments herein shown. Thus variations may be made within the scope and spirit of the accompanying claims without sacrificing the principal advantages of the invention.

1.-22. (canceled)

23. A method of manufacturing an integrated receiver condenser wherein a first half and a second half of a receiver are joined together to form the receiver.

24. A method of manufacturing an integrated receiver condenser as claimed in claim 23 comprising the steps of:
inserting a first end of a pair of connectors in openings provided in the first half of a receiver tank and caulking the ends,
fitting a cap support to at least one half of the receiver tank at the bottom, inserting the other end of the connectors in to corresponding openings in the tank header of a condenser and caulking the ends thereof,
caulking the tank header of the condenser to the plate header of the condenser by means of ribs provided on the edges of the tank header,
caulking a separator to the second half of the receiver tank,
caulking the second half and the first half of the receiver tank by means of ribs on the edges of the second half,
fitting a receiver cap on the first half and second half of the receiver tank at the top,
screwing a cap filter sub-assembly on to the cap support thereby forming an integrated receiver condenser for final brazing in the brazing furnace.

25.-26. (canceled)
